(19) United States
(12) Patent Application Publication
(10) Pub. No.: US 2001/0029882 A1
(43) Pub. Date: Oct. 18, 2001

(54) Personnel guidance and location control system

(76) Inventors: Dan Pharo, Valencia, CA (US); Alex J. Humbree, Salt Lake City, UT (US)

Correspondence Address: ROBERT J. SCHAAP, 21241 Ventura Boulevard, Suite 188, Woodland Hills, CA, 91364, US

(21) Appl. No.: 09/758,934

(22) Filed: Jan. 11, 2001

Related U.S. Application Data
(60) Provisional application No. 60/175,293, filed on Jan. 10, 2000.
(60) Provisional application No. 60/084,591, filed on May 7, 1998.

(51) Int. Cl. G09F 19/00

(52) U.S. Cl. 116/200; 116/209

(57) ABSTRACT

A personnel guidance and location control system for locating a group of individuals in a line to reach a selected destination in advance of the end of that line, such as a group of individuals waiting to reach a bank teller. The individuals are guided in a guide path by indica on one or more mats which can be conveniently disposed upon the floor of an institution and arranged to form a guide path. In addition, fixed guidance elements, such as physical markers, may be used with the floor mats in order to further identify points where the group of individuals should turn or otherwise alter directions. In addition, the mats are uniquely designed so as to present informational messages, such as advertising, or other material on a surface thereof. Further, the mats are constructed so that they are rollable, but nevertheless, very durable and do not crack or cause wrinkling of any image upon rolling thereof.

### BACKGROUND OF THE INVENTION

1. Field of the Invention

This invention relates in general to certain new and useful improvements in floor mats designed for personnel guidance and location control and, more particularly, to floor mats of this type which are also capable of presenting informational messages on the surface thereof and which can be easily altered as well as to mats of the type stated which are capable of being rolled for storage and transport without destroying the informational message thereon.

2. Brief Description of Related Art

In my basic parent patent application Ser. No. 08/741,619, filed Oct. 30, 1996, there was illustrated and described a personnel guidance and location control system in which a group of individuals were guided to a destination in a guidance path and which destination was in advance of an end of the line position of that guidance path. This application disclosed various means, such as physical markers, for mounting to a ground surface to identify the boundaries of the guidance path and the end of the line position therefor.

In my subsequent utility patent application Ser. No. 09/307,337, May 6, 1999, there was illustrated and described an additional system in which guidance elements could be provided on a mat or carpet-like member and which could be secured to a floor surface. In addition, a plurality of interlocking mats was also disclosed so as to enable the formation of a guidance path of a selected design.

In my U.S. utility patent application Ser. No. 09/307,104, filed May 6, 1999, there was a personnel guidance and location control system somewhat similar to those in the previous two utility patent applications. In this latter application, there was also disclosed various means for presenting messages on the surface of the mats which were disposed on a ground surface. These messages were shown as being advertising messages or informational material to be presented to personnel standing in the guidance pathway. There was also disclosed a particular destination mat or group of mats which represented a position for parties to stand at a particular destination.

It has been found in connection with the present invention that there has been a need for a personnel guidance and location control system for guiding a group of pedestrian individuals in a pathway by the use of mats which can be disposed on a ground surface and in a desired orientation to guide that group of individuals. It is also preferred to use mats of selected construction which presents some rigidity, but yet which still allow for rolling thereof to enable transport and storage. These mats must be capable of being constructed so that they do not crack or otherwise mar any advertising material or other promotional or informational material presented on the upper surface of the mat. In addition, mats of this type must also be capable of being disposed on a ground surface so that the mats will not slip or move when an individual first stands on the mat or moves while standing on the mat.

It was found in connection with the aforementioned U.S. patent applications that it is frequently necessary to change the advertising material on the floor mat without the necessity of preparing an entirely new floor mat. It was also found that it would be desirable to alter the guidance elements which disclose the pathway for guiding the group of individuals from time to time, again without the necessary of creating an entirely new floor mat therefor. Thus, the applicants have found that it is necessary to provide a floor mat in which indicia on the upper surface of that mat, whether it be informational material or guidance pathway elements, can be altered without destroying or the necessity to create new mats.

In addition to the foregoing, the applicants have also found that it is necessary to provide a mat which has a relatively light weight, but which can still nevertheless have some moderate rigidity so as to avoid the marring of the surface finish of the mat or otherwise marring informational material presented on the mat. In addition, the mat must be capable of being rolled for storage and transport without wrinkling or otherwise marring guidance elements located near the edges of the mat.

It has been found that unless the mat has at least some rigidity, but yet is still capable of being rolled for storage or transport, that in the rolling process the informational material and, for that matter, the guidance elements themselves can be wrinkled or otherwise bent, such that they lose their aesthetic appearance. In many cases if the mat is not stored properly, and in a relatively flat position, then the advertising material becomes marred to the point where the advertiser will cease the use of the floor mat as an advertising medium.

It has also been found in accordance with the present invention that for purposes of cleaning the floor surface, the mats must frequently be removed as, for example, in restaurants and the like. Here again, the mats must be capable of being picked up and moved to a different location during the cleaning process. Consequently, they had to present some rigidity so that the mats could be literally picked up and moved. It was found that flexible mats of the type which had little or no rigidity would literally require two or more individuals to pick up the mat and move same. In addition, rolling and even slight flexing during handling of the mats during movement causes minute cracks in the informational message tending to mar its appearance.

The conventional floor mats readily suffer from problems of deterioration in harsh weather conditions and in inclimate weather conditions. This is particularly true if the floor mats are located in inclimate weathering conditions. These mats must be capable of withstanding extreme cold conditions in the winter and relatively hot conditions in the summer without cracking or deteriorating as a result thereof. In addition, they must be somewhat immune to ultraviolet radiation from the sun or other light source which would tend to cause opaqueness of an upper transparent plastic surface and which would also cause edges of the mat to curl.

There are numerous floor mats which have been designed for presenting informational material on the upper surface thereof. One such floor mat in described in U.S. Pat. No. 5,848,830, to Castle, et al and which even includes means for illumination thereof. This particular patent discloses the use of advertising or promotional material. Another mat capable of being used is disclosed in U.S. Pat. No. 5,775,016 to Chien and which contains guidance material to an exit in case of an emergency or otherwise. U.S. Pat. No. 5,637,378 to Hensler, et al also discloses a floor mat but which contains fluorescent borders. However, these borders are not designed as guidance and location control elements. Rather, they are designed to show the edges of the mat in the event of a power failure.

Other U.S. patents which disclose mats contain emergency personnel movement directions and include, for example, U.S. Pat. No. 4,401,054 to Britt, et al; U.S. Pat. No. 4,109,439, to Feasel; U.S. Pat. No. 4,080,087 to Phillips; U.S. Pat. No. 4,570,207 to Takahashi, et al; U.S. Pat. No. 4,737,764 to Harrision; U.S. Pat. No. 6,025,773 to Bresnan; U.S. Pat. No. 4,791,114 to Mandel; U.S. Pat. No. 4,620,816 to Kupfer.

The use of personnel guidance and control systems is well known and used for controlling the path of movement of a group of individuals in an activity. They are also frequently used for presenting entertainment or information to a pedestrian while waiting to reach a certain destination in advance of a line of these individuals. Generally, all of the conventional guidance and location control systems rely upon the use of movable standing poles mounted on heavy base plates and also use cables, ropes or chains thereby defining a pathway for the individuals. There have also been attempts to provide personnel guidance and location control systems which rely upon lines painted on a ground surface defining a guidance path. While the physical barriers, such as the poles and the like, are effective, they are subject to theft or vandalism. Moreover, when located in an exterior environment, they are also subject to degradation from the environmental conditions and, particularly, during inclimate weather.

The use of poles holding guide ropes also has another drawback with regard to small children. In many cases, the children would attempt to either sit on the guide ropes causing the poles to tip and allowing the child to strike the ground surface, thereby resulting in injury. There have been attempts, particularly with children, and even some adults, to stretch spring loaded retractable cables allowing them to return to their original position. If these cables strike an individual when stretched, they can again cause injury to the individual.

It would also be preferable to provide a guidance and control system which relies upon markers on mats disposed on the ground surface, but also along with an occasional physical barrier designed to further provide guidance movement to the pedestrian individuals.

Heretofore, there has not been any effective guidance and location control system which relies upon the use of floor mats having informational material presented thereon and which are capable of being rolled and which are nevertheless sufficiently rigid so that they are capable of being picked up by an individual and moved to another location and where the rolling or flexing of the mat does not mar or otherwise damage the informational material presented on the mat. It would also be desirable to provide a personnel guidance and location control system which relies upon a mat having indicia to identify a path of movement and which could also be used with an occasional upstanding physical indicator for guidance and control.

### OBJECTS OF THE INVENTION

It is, therefore, one of the primary objects of the present invention to provide a personnel guidance and location control system which relies upon the use of one or more individual floor mats arranged in a certain pattern and which can contain removable and interchangeable indicia on the upper surface thereof for providing a guidance path.

It is another object of the present invention to provide a personnel guidance and location control system of the type stated which relies upon the use of floor mats of the type also capable of having informational material presented thereon along with guidance pathway elements formed thereon.

It is a further object of the present invention to provide a personnel guidance and location control system of the type stated which has a substantial amount of rigidity, but which can nevertheless be rolled for purposes of storage and transport and which can be physically moved by a single individual.

It is an additional object of the present invention to provide a personnel guidance and location control system of the type stated using floor mats of the type which can be rolled or stored in a flat condition without marring or otherwise deleteriously affecting either guidance elements on the upper surface thereof or informational material presented at the upper surface of such floor mats.

It is another important object of the present invention to provide a personnel guidance and location control system of the type stated in which guidance elements identifying a pathway for individuals or other informational material presented thereon can be easily and rapidly changed without the need for discarding the floor mat or otherwise requiring substantial modification of the floor mat.

It is still a further object of the present invention to provide a plurality of floor mats forming part of a location guidance and control system of the type stated which can be manufactured at a relatively low cost, which are highly durable in construction and effective in causing a group of individuals to follow a guidance path identified thereby.

It is another salient object of the present invention to provide a series of floor mats in a location and guidance control system for causing a group of individuals to follow a guidance path and which also presents informational material on an upper surface thereof and which can be rolled or stacked in a flat condition for storage and transport without otherwise deleteriously affecting such informational material.

With the above and other objects in view, our invention resides in the novel features of form, construction, arrangement and combination of parts and components presently described and pointed out in the claims.

### BRIEF SUMMARY OF THE INVENTION

A personnel guidance and location control system for controlling and guiding a group of pedestrian individuals in a selected path to a waiting point, and then to an activity in advance of that waiting point. In another embodiment of the invention, the guidance and location control system will operate as a type of cuing system for guiding a group of individuals to a selected destination. In each embodiment, the guidance and location control system comprises at least one or more floor mats capable of being disposed upon a floor surface.

The floor mats may be used in combinations to identify a particular configuration of a pathway. Thus, for example, individual floor mats having a linear shape can be endwise connected together to form a linear path. Otherwise, floor mats having an arcuate shape can also be used on the end of or at portions along the linear path to identify a different orientation of the pathway. These various floor mats can be connected together or otherwise abutted against one another.

In addition, the floor mats may be used individually to represent a particular destination as, for example, where one or more individuals would stand, e.g. at a soda fountain so as to withdraw a soft drink from that soda fountain. However, it is important to note that in each case, guidance elements may be formed on the edges of each of the mats to identify the guidance pathway formed thereon. Moreover, footstep designs may be provided on the surface of the mat and within the guidance pathway to more specifically identify the specific pathway in which the individuals are to walk or wait.

A head of the line position marker may also be used where the individuals are to wait at a head of the line position to move to destination in advance of the end of the line. In effect, these edge markers are guide path-forming elements which define the edges of a pedestrian guide path. Typically, the guide path will turn or have other variations in its location in order conform to a fixed existing floor structure or a counter or like furniture structure.

In accordance with the present invention, an upstanding barrier element may be located at one or more portions where the guide path turns or otherwise deviates from a linear path. Thus, if a path is to make a left hand turn or turn in a curve, such as a “U” turn, an upstanding physical guide element can be located at that point. This guide element, which does not necessarily function as a barrier element, comprises a floor plate which can be mounted on or even under a portion of a floor substrate. An upstanding physical guide element extends upwardly from the floor plate and presents a point for the individual to turn or otherwise deviate from a straight path.

The term “barrier element” as used herein is not actually used to specifically represent a barrier, as such, much in the manner as poles and ropes. Rather, and although it is an upstanding physical element, its primary function is to identify a position where a pathway may turn or otherwise adopt a different course. It can even be used along the side of a linear pathway. Nevertheless, since it is formed of a plastic material and, for that matter, even a somewhat yieldable plastic material, it does not constitute a physical barrier designed to hold people within a certain pathway.

In another embodiment, the guide path is no wider than a conventional four passenger automotive vehicle. Generally, and even in a more preferred embodiment, the guide path should not exceed sixty inches in width and, even preferably, fifty inches or less in width. In yet another embodiment, the floor mats are not specifically designed to provide a guidance path but may be used to represent a destination or, for that matter, a particular location, such as a point of entry at a door or other physical structure. Thus, the floor mat could be located at a doorway to identify an entrance or an exit and may even include footprint marks thereon to show the direction of movement. Otherwise, and as indicated previously, the mat may represent a particular destination, such as a location where one or more individuals will temporarily stand while undertaking a certain activity. In each case, the floor mats will generally have indicia on the upper surface which may be guidance pathway indicia where the floor mat serves as part of a guidance path or otherwise informational indicia which may include, for example, advertising and promotional indicia, such as advertising or promotional messages.

In still a further embodiment of the invention, a floor substrate in the form of a mat can also be provided. The preferred mats use a laminated construction and comprises a layer formed of a polycarbonate material, as a top layer. One of the preferred polycarbonates is that know as Lexan. In another embodiment, a multi-layer floor substrate or mat is also provided and is made from a somewhat rigid but nevertheless flexible plastic, such as the polycarbonate layer, mentioned above. Applied to a lower surface of the polycarbonate layer is an acrylonitrile butadiene styrene co-polymer (ABS) layer. This ABS layer is somewhat flexible and rollable. It therefore allows the more rigid polycarbonate layer to be at least rolled. However, the polycarbonate layer will enable the edges of the mat to lay in contact with a floor surface.

If desired, a vinyl or rubber layer may be secured to the bottom of the ABS layer in order to provide further sound reduction and floor gripping capability. However, it has been found in connection with the present invention that the ABS material or similar plastic material can be altered to provide excellent floor gripping capability and also sound reduction.

The individual substrates may be made in eight foot panels, for example. Inasmuch as they are somewhat rigid, they are easy to pick up and flip over for floor cleaning and the like. In distinction thereto, the prior art floor mats were flexible and curled up. As a result, it was difficult to properly clean the mat and then relay the mat in a proper position. Furthermore, any bending or severe rolling of the mat would cause any graphic material imprinted on the surface to crease and break up.

The polycarbonate material is initially transparent and coated with a somewhat opaque material. This coating allows any message imprinted on its under-face to migrate through the polycarbonate layer and to show at the upper surface thereof. In this way, the printed message or other informational material will not be marred by walking on the surface of the mat.

If desired, additional informational material can be placed on the mat to literally cover that on the underside of the polycarbonate layer. These informational appliques applied to the upper surface of the mat can be periodically changes or altered.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a schematic top plan view showing one form of personnel guidance and location control system of the present invention;

FIG. 2 is a perspective view of one form of physical barrier which may used with the personnel guidance and location control system of the present invention;

FIG. 3 is a schematic top plan view similar to FIG. 1, but showing the desired position of the physical barrier of FIG. 2;

FIG. 4 is a perspective view of one form of floor mat on floor covering which may be used in the present invention;

FIG. 5 is a vertical sectional view taken essentially along line 5-5 of FIG. 4;

FIG. 6 is a fragmentary sectional view showing a modified form of mat construction in accordance with the present invention;

FIG. 7 is a fragmentary vertical sectional view showing the application of informational material to an undersurface of the upper layer of the mat;

FIG. 8 is a fragmentary top plan view showing the mat forming part of a guidance and location control system with guidance elements thereon and a message presented on the surface thereof;

FIG. 9 is a fragmentary top plan view, similar to FIG. 7, and showing a portion of a floor mat similarly forming part of a guidance and location control system and having guidance elements and an informational message at the upper surface thereof;

FIG. 10 is a fragmentary sectional view, similar to FIG. 6, and showing the application of additional informational material to the upper surface of the upper layer of the mat;

FIG. 11 is a fragmentary sectional view showing a modified form of mat construction in accordance with and embodying the present invention and with openings in the upper surface to receive guidance pathway elements;

FIG. 12 is a fragmentary sectional view, similar to FIG. 11, and showing the mat of FIG. 11 with guidance pathway elements incorporated therein;

FIG. 13 is a fragmentary sectional view, similar to FIGS. 11 and 12, and showing appliques applied to the upper surface of the guidance pathway elements of FIG. 11;

FIG. 14 is a fragmentary sectional view showing another modified form of mat forming part of a guidance and location control system and which uses a source of electric light in the mat; and

FIG. 15 is a top plan view showing a plurality of mat forming elements to define a guidance and location control system as well as a destination position in advance thereof and use the floor mats of the present invention.

### DETAILED DESCRIPTION OF A PREFERRED EMBODIMENT

This present invention supplements and embodies the subject matter contained in my pending U.S. patent application Ser. No. 09/347,255, filed Jul. 2, 1999, for Personnel Guidance and Location Control System, the latter of which is also incorporated herein by reference. To some extent, the subject matter of those other earlier identified patent applications may be incorporated in the guidance and location control system of the invention. Thus, many of the details of these Personnel Guidance and Location Control Systems are briefly discussed and therefore are not set forth and described at length herein. Nevertheless, they are incorporated by reference.

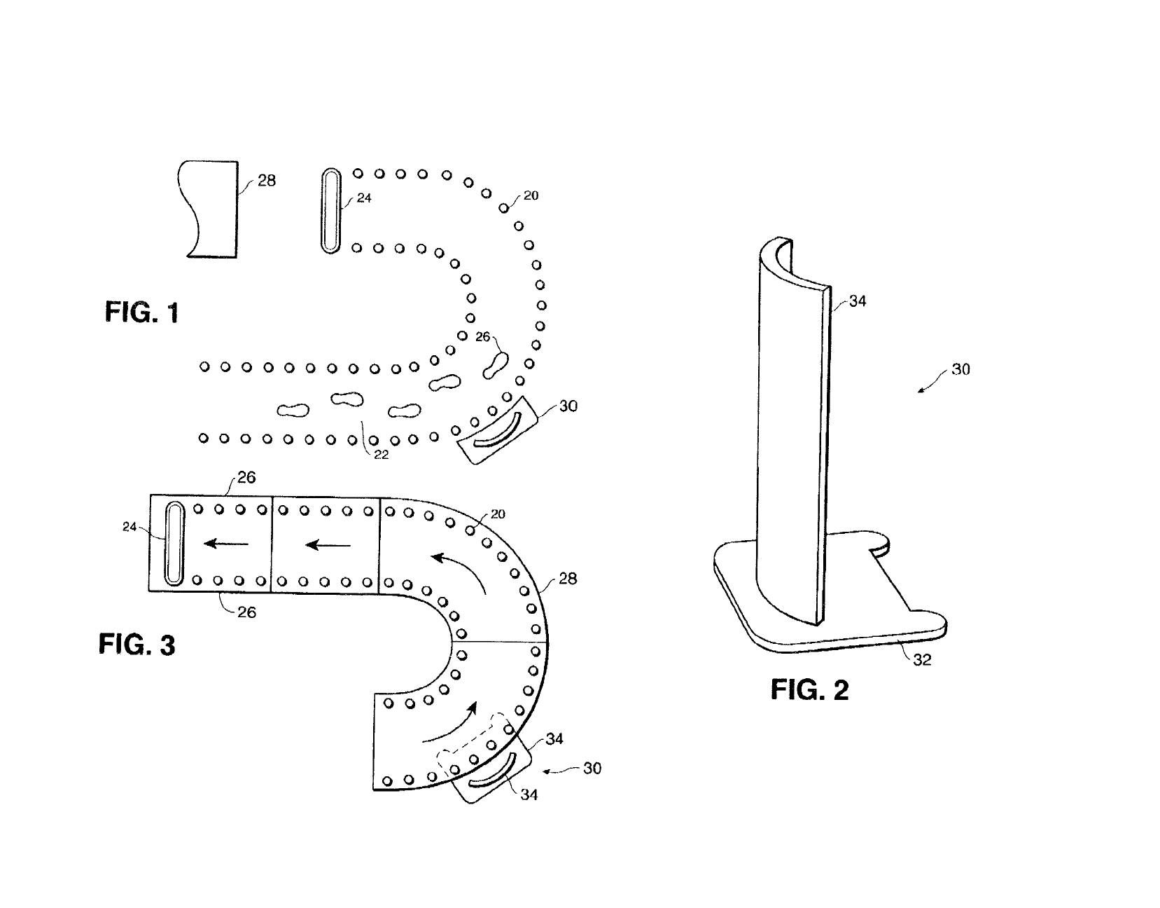

Referring to FIG. 1, it can be observed that there are a plurality of pathway forming discrete edge elements as, for example, floor or ground mountable small discrete markers 10 which form a guide path 22 for a plurality of individuals waiting, for example, in a line. There is also an elongate end of the line element 24 which defines the end of that guide path 22. In addition, and if desired, footprints 26 may also be provided, as shown in the embodiment of FIG. 1, to further outline the queuing arrangement for the group of individuals. In this particular embodiment, the guide pathway forming elements 10 and the end of the line element 24 are discrete components which are physically mounted to a floor surface, much in the manner as described in my co-pending U.S. patent application Ser. No. 09/307,337, filed May 6, 1999.

The present invention thereby eliminates the need for ropes and poles as a conventional guidance and location control system and the problems attendant thereto. It should be understood in connection with the present invention that these guidance elements, including the small discrete elements 20, and the end of the line position element 24 could be physical elements which are physically applied to a floor including a ground surface or a similar substrate as, for example, by means of screws, nails, etc. Otherwise, it should also be understood that these elements may be imprinted on or otherwise applied to a surface of a mat, as hereinafter described in more detail.

FIG. 1 also shows a destination 18 which may be, for example, a kiosk or a bank teller cage or the like. In this particular case then, the group of individuals would be waiting to reach that destination 28 in advance of the end of the line position.

It has been found in connection with the present invention that in many cases, people will attempt to avoid the markers, at least temporarily, to reach a selected position in the guide path when there are only a few individuals in the proximity thereof. This can be disruptive, particularly in restaurants and like facilities where other patrons may be carrying trays, etc. It has been found also in connection with the present invention that the use of a physical barrier requiring ropes and poles can also be helpful for this purpose, but these ropes and poles and like physical barriers do interfere with movement of people and can also present a hazard. Thus, while they tend to guide people, they also are a potential hazard, including some of the hazards mentioned above.

The present invention therefore provides a physical barrier element which does not serve to operate as a barrier, per se, but rather an upstanding guidance element which further defines a guidance pathway. In addition, this upstanding barrier element or guidance element actually can serve as a physical barrier, although it is essentially light weight, movable and, for that matter, even yieldable. The physical guidance element of the invention is primarily designed to identify a position where the path may turn. For that individual or group of individuals who are not paying attention to the particular orientation of the path, the physical barrier in advance of a turn or other change in orientation of the pathway will be alerted to that fact. Moreover, there is only a need for one or a few of these individual guidance elements. To that extent, they do not constitute an actual group of physical barriers, such as ropes and poles, but rather merely aid in identifying the orientation of the pathway.

The physical guidance element 30, as illustrated in FIG. 2, is primarily used to designate a position where the pathway makes an abrupt turn as, for example, to the right or the left or, makes a U-turn, particularly as shown in the embodiment of FIG. 3.

This physical barrier 30 in this embodiment is provided with a floor plate 32 and upstanding element 34. The floor plate 32 is adapted to either be mounted to a floor or just located in a fixed position without being mounted. In addition, the floor plate is specifically designed to have an enlarged front section, as shown, so that it may be fitted under a portion of a mat, particularly as shown in the embodiment of FIG. 3. In this way, the physical barrier 30 may be held in a fixed position by means of the floor mat. Further, and for this purpose, the floor plate 22 may be of a relatively thin construction so that the floor plate will not cause a bulging or uplifting of the mats 10. In addition, a portion of the lower layer of the mat can be removed to accommodate the floor plate.

By further reference to FIG. 3, it can be observed that the individual path defining elements 20 are physically mounted on individual mats 36 which are linear in shape and arcuately shaped mats 38. These mats may be abutted together or they may be affixed together in any desired orientation, in the manner as shown in our co-pending U.S. patent application Ser. No. 09/307,337, filed May 6, 1999. For this purpose, the edges of the mats may be provided with interlocking sections so as to enable the mats to fit together in an interlocked arrangement.

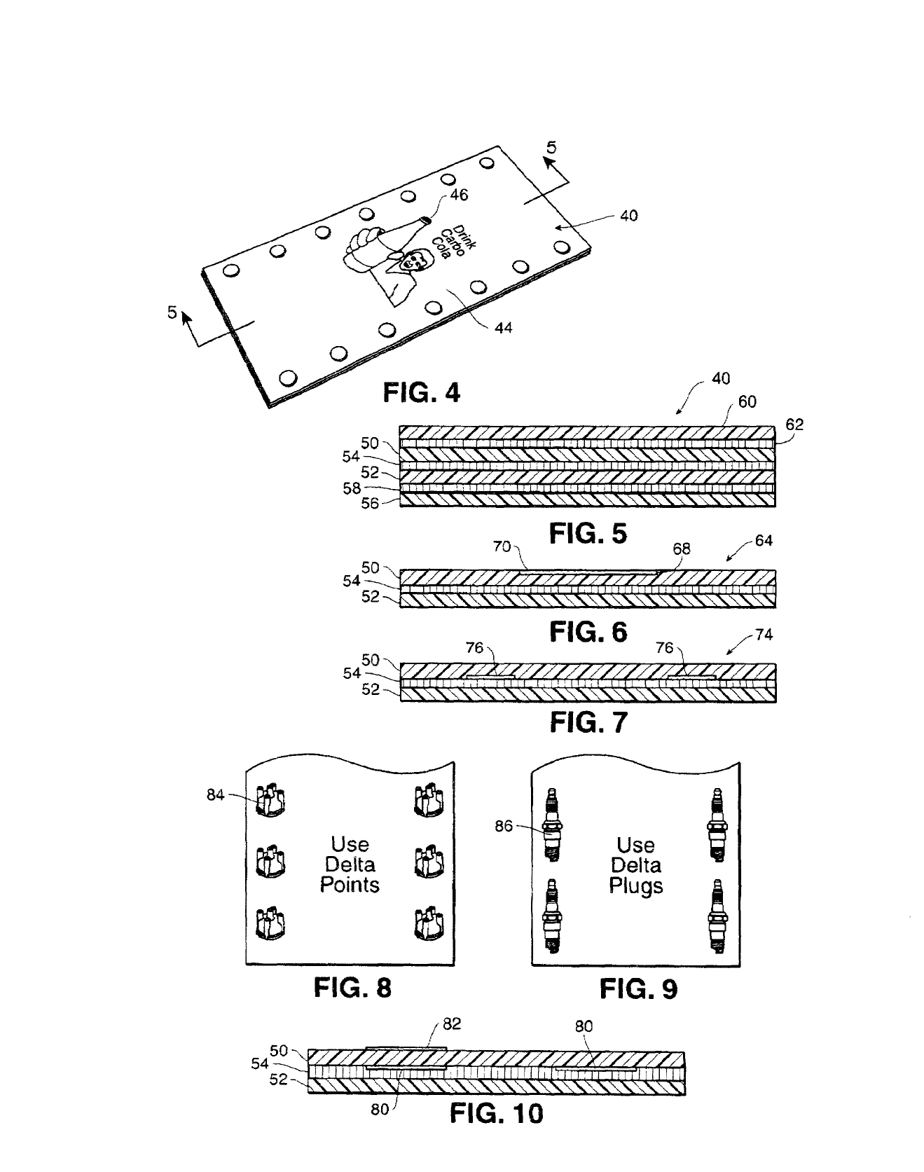

The present invention also provides a plurality of embodiments of a unique floor mat 40 which carries the guidance and location control system thereon, as best shown in FIGS. 4-13 of the drawings. In this particular case, a floor mat 40 is comprised of a plurality of individual layers and may have imprinted or otherwise applied to the upper surface thereof a plurality of small discrete elements 42 defining a guide path 44. In addition, an advertisement section 36 may be imprinted on or otherwise applied to this mat 40. This mat essentially forms part of a guidance and location control system for guiding a group of individuals. Otherwise, it could be merely serve as a destination mat in which a party stands to accomplish a certain physical result.

By reference to FIG. 5, it can be observed that the mat is a plural layer mat which may be die cut or otherwise formed. The mat 40 of the present invention comprises a fairly rigid substrate 50 which may be formed of a plastic material, such as a polycarbonate. Any of a number of well known polycarbonate materials may be operable for this purpose. Although the polycarbonates have been found to be most effective for the present invention, it is possible to use other moderately rigid plastics, such as polystyrene, and even some polyethylene blends. The fairly rigid layer 50 should be capable of providing a substantial degree of rigidity to the mat so that it cannot be folded. Moreover, it must present at least sufficient weight to preclude edges of the mat from curling, particularly when the mat is not necessarily interlocked with other related mats. It may be appreciated that curling of the mat, particularly at the edges, can present a hazard, such as a tripping hazard.

That polycarbonate material which is offered under the name and mark “Lexan” is even most preferred, since it has a relatively scratch resistant top surface. Moreover, it is quite durable and even in relatively thin sections is not readily bendable. In addition, the Lexan or other polycarbonate layer should have a relatively thin cross sectional thickness as hereinafter described in more detail.

Secured to the under surface of the polycarbonate layer 50 is a plastic layer 52 and preferably one formed of an acrylonitrile butadiene styrene co-polymer. This particular material is secured to the underside of the polycarbonate layer by means of a thin adhesive film 54, as best shown in FIG. 5 of the drawings. The layer 52 provides some degree of flexibility to the mat and cooperates with the moderately rigid polycarbonate material to at least allow the mat to be rolled somewhat about a moderately large diameter. In this way, one of more mats can be rolled together for storage and/or transport. In like manner, the polycarbonate layer provides sufficient rigidity so that the mats can be stacked and stored on top of one another in a flat condition. In addition, and notwithstanding the presence of the acrylonitrile butadiene styrene layer, the polycarbonate material provides sufficient rigidity so that the edges of the mat do not curl upwardly when disposed on a floor surface.

The acrylonitrile butadiene styrene layer also is effective in presenting a substantial gripping surface for gripping to a floor surface including, for example, a relatively smooth ceramic tile surface. Moreover, it operates to hold a mat in a fixed position on a floor surface without the necessity of mounting to the floor.

It should be understood that other plastic materials could be used in place of the acrylonitrile butadiene styrene material, including, for example, a polybutadiene layer. Other materials which provide some gripping capability could also be used for this purpose. However, the acrylonitrile butadiene styrene copolymer material is the most preferred co-polymer found to be available for these floor mats.

If desired, an additional vinyl layer 56 may be located on the underside of the acrylonitrile butadiene styrene layer 52 and secured thereto by means of an adhesive layer 58, also as best shown in FIG. 5 of the drawings. Again, this vinyl layer would have somewhat of a rough surface finish and would also be formed so as to provide a tight gripping action to a floor surface. However, it has been found that when the ABS plastic is properly formulated, it provides sufficient gripping action for engagement with a floor surface. Further, a rubber cement-type layer can also be applied to the bottom surface of the ABS plastic. This rubber cement-type layer would be used in place of a vinyl layer for lockably retaining the mat in a secured position on the floor, but would still nevertheless allow the mat to be easily removed from the floor, if desired.

If desired, an upper panel 60 may also be applied to the upper surface of the polycarbonate layer 50 and secured thereto by means of an adhesive layer 62. Again, the upper layer 60 would merely be designed as a protective layer and would also be formed in such manner that it generally presents a non-slip surface. However, and though it can optionally be employed, it has been found that the polycarbonate is usually sufficient to preclude marring and resist other surface imperfections resulting from use and wear.

Thus, and in accordance with the present invention, the most preferred mat construction would comprise a polycarbonate layer having an acrylonitrile butadiene styrene layer secured to its underside through a relatively thin adhesive layer. However, the other plastic materials could be used in place of the polycarbonate and the acrylonitrile butadiene styrene material, as aforesaid.

FIG. 6 illustrates an embodiment of the a mat 64 which is comprised only of the acrylonitrile butadiene styrene layer 52 and the upper polyearbonate layer 50, as well as the thin adhesive layer 54. In this embodiment of FIG. 6 as well as subsequent embodiments, like reference numerals will be used to represent like components which were described in the previous embodiments of the invention.

In the mat 64, the mat is provided with a slightly recessed section 68 having an information bearing section 70 inserted in the recess 68 as a type of insert. Moreover, this insert 70 can be frictionally fitted within the recess 68 or otherwise it can be permanently secured therein by means of an adhesive or cement. Although this type of presentation of material is effective, it is more preferable to use one of the subsequently described embodiments of the mats in accordance with the present invention.

FIG. 7 represents a mat 74 which similarly carries the ABS layer 52 and the polycarbonate layer 50 secured by the adhesive layer 54. In this case, one or more message presenting layers 76 can be located on the underside of the polycarbonate layer 50 or on the upper surface of the acrylonitrile butadiene styrene layer 52. In this way, the advertising message is effectively located on the underside of the polycarbonate layer 50 and is carried through the layer to the upper surface which is generally transparent. In this way, the informational message carried by the substrate 76 will appear clearly through the upper surface of the polycarbonate layer 50. In addition, since the coating applied to the layer 50 is white, the message will appear against a white background.

The image which is to appear through the polycarbonate layer may also be applied through an ink printing on the undersurface of the polycarbonate. When the ink is dried, the adhesive is then applied and allows for the bonding or lamination between the ABS layer and the polycarbonate layer.

The informational message which is to be displayed at the upper surface of the laminated mat may suitably be applied to the underside of the polycarbonate layer 50, as best shown in FIG. 10. Thus, suitable informational messages are applied to the undersurface of the polycarbonate layer 50 and above the upper surface of the ABS layer 52, as well as, in this case, above the adhesive layer 54. This informational material may adopt the form of ink printing on the underside of the polycarbonate layer 50 or it may adopt the form of thin substrates 80 applied to the underside of the polycarbonate layer 50, as shown. In either case, the message appears through the transparent polycarbonate layer 50.

If it is desired to cover the message which may be presented, such as that message 80, an applique 82 may be adhesively secured to the upper surface of the polycarbonate layer 50 directly over the message 80, as best shown in FIG. 10 of the drawings. In this way, it is easily possible to alter the design which may appear on the surface of the mat or, for that matter, to alter the appearance of the guide pathway forming members 42.

FIG. 9 illustrates a plan view of one embodiment of a mat, such as that mat of FIG. 10, and which includes guide forming edge indicia 84 which may be in the nature of, for example, the distributor points for use in an automobile. In the event one desires to change the points to a different illustration as, for example, spark plugs 86, as shown in FIG. 8, it is only necessary to apply an applique over the illustration of the points and to generate a design of a series of spark plugs. Thus, for example, if the institution in which the mat is used is having a sale on distributor points, they may wish to emphasize the points, as shown in FIG. 9. If the sale item should change to spark plugs on the following day, they would feature the spark plug designs, as shown in FIG. 8.

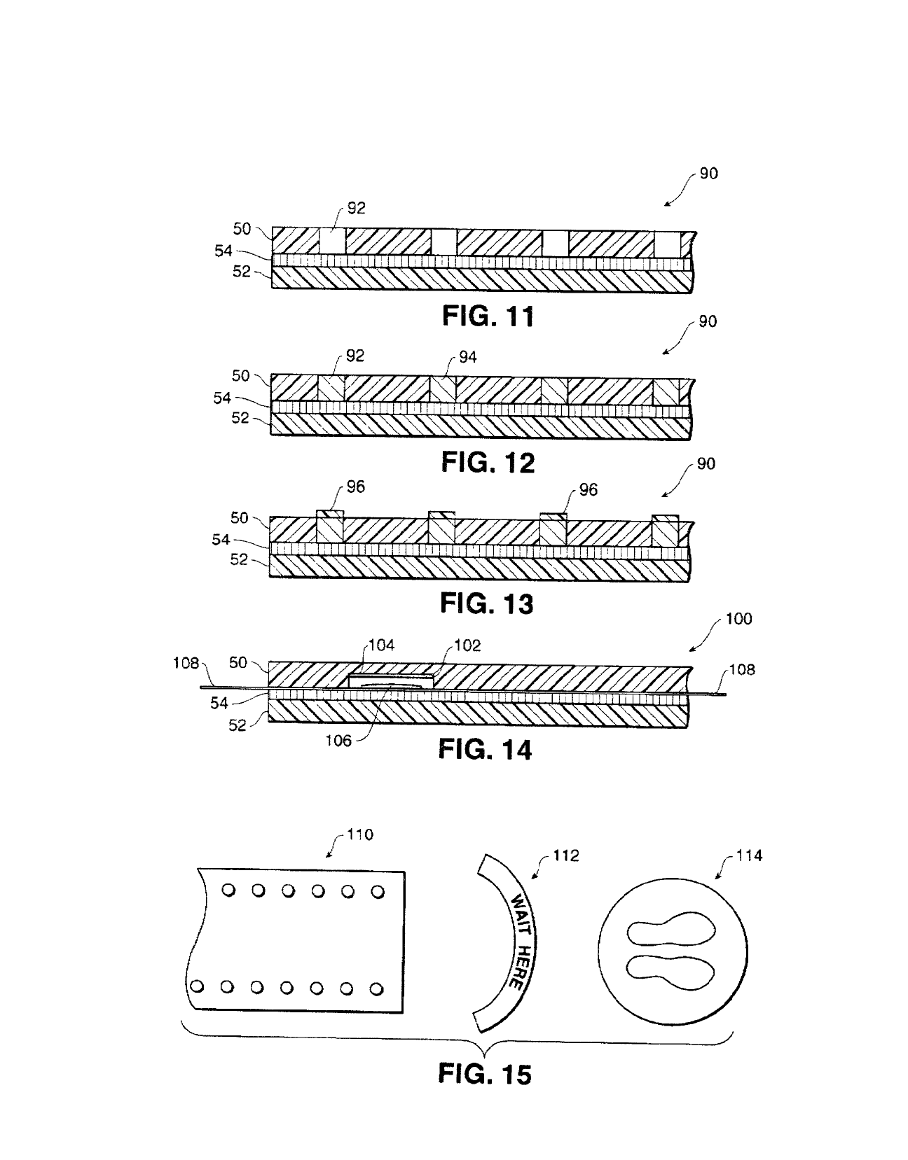

FIGS. 11-13 illustrate an embodiment of a mat 90 having the polycarbonate layer 50 and the ABS layer 52 secured by the adhesive layer 54. In this embodiment, the polycarbonate layer is provided with openings 92, as shown in FIG. 11, for receiving plugs 94 and which plugs 94 may contain on their upper surface an informational message to be presented. Otherwise, a plurality of these plugs 94 in combination may present a message. The plugs are sized to fit within the openings 92 and can be frictionally retained therein or otherwise they may be adhesively secured within the openings 92. The plugs, for example, may actually adopt the form of the guide path forming elements 84 or 86. In the event that the plugs are permanently secured within the openings 92, it is possible to change the message presented on the surface of the mat or the plugs by merely adhesively securing an applique 96 to the upper surface of each of the plugs, as best shown in FIG. 13 of the drawings.

FIG. 14 illustrates an embodiment of a mat 100 which is substantially identical to the previously described mat of FIG. 10, and includes the polycarbonate layer 50 and the ABS layer 52 as well as the adhesive layer 54. In this case, a substrate 102 having an informational message on the upper surface thereof is located within a recess 104 formed in the bottom surface of the polycarbonate layer 50. In addition, a light 106 can also be located in the recess 104 immediately beneath the substrate 102 carrying the informational message. Moreover, the light is powered through an electrical wire 108 which would be carried through the laminate mat in the adhesive layer 54, all in the manner as best shown in FIG. 14 of the drawings. This embodiment of the invention illustrates how the mat could actually be lighted selectively. Moreover, by connecting the wires 108 to a suitable control circuit, it is possible to obtain desired lighting patterns.

FIG. 15 illustrates an embodiment of the invention in which there are a plurality of individual mats, such as mats 110, 112 and 114. The mat 110 is designed to guide a plurality of individuals to a selected stopping point identified by the mat section 112. From there, the individuals may take turns to reach a destination represented by the mat 114. This embodiment of the invention shows how a plurality of mats in combination can be used to achieve the desired movement of a group of individuals to a particular destination.

The various embodiments of the mats of the present invention nevertheless allow for easy removal of the entire mat so that each can be flipped over to enable easy floor cleaning and the like. Thus, the mat does not suffer from the disadvantages of the prior art and is an effective guidance and location control system which can be directly applied to a floor surface.

The plastic layer, such as the acrylonitrile butadiene styrene layer 52, should have a thickness of approximately 3/32 inches or less. Moreover, the panels preferably have a length of about eight feet, although, again, the overall length can vary as does the thickness of the individual layers. The polycarbonate upper layer should have a thickness of no less then about 10 mills and the adhesive which is used in the layer 54 should have a thickness of about 4 mills. The Lexan plastic layer 50 should also have a thickness of about 3/32 of an inch. In this way, the entire mat is no more than about 7/32 of an inch thick, including any message which may be applied to the upper surface thereof.

Thus, there has been illustrated and described a unique and novel personnel guide and location control system which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what we desire to claim and secure by Letters Patent is:

1. A personnel guidance and location control system for guiding a group of walking pedestrian individuals into a line thereof and controlling movement thereof, said guidance and location control system comprising:
a) a ground cover substrate for disposition on a ground surface;
b) at least one end of line element associated with said cover substrate and in a fixed location thereon for defining an end of a line of the group of walking pedestrian individuals and representing a waiting location for the individual at the front end of the line so that the individuals may proceed to a destination in advance of the front end of the line in an orderly and succession manner;
c) a plurality of small discrete path forming elements associated with said cover substrate in a fixed location thereon relative to the end of line element and extending from regions in proximity to opposite ends of the end of line element to define a pathway of movement for the group of individuals;
d) means associated with said end of line element and small discrete path forming elements for locating same with the cover substrate, whereby the ground cover substrate and end of line element and small discrete path forming elements can be located on the ground surface presenting a desired pattern to enable the orderly and controlled movement of a group of walking pedestrian individuals into one or more lines of same to a destination; and
e) at least one upstanding guide post located in proximity to an edge of said ground cover substrate to alert the pedestrian in the pathway of a potential change of orientation of the pathway in advance of reaching that change of orientation.

2. The personnel guidance and location control system of claim 1 further characterized in that the guide post comprises a plate and an upstanding member extending from said plate and located at the edge of said substrate.

3. The personnel guidance and location control system of claim 2 further characterized in that said guide post is relatively light in weight and movable from one location to another.

4. The personnel guidance and location control system of claim 1 further characterized in that said guide post does not primarily serve as a physical barrier but is visually apparent to guide the pedestrian individuals.

5. The personnel guidance and location control system of claim 1 further characterized in that a fastening means is associated with the underside of the end of line element and with the underside of the small discrete path forming elements for securing same to said ground cover substrate.

6. A system for controlling movement and standing locations of pedestrian personnel and presenting informational messages in connection therewith, said system comprising:
a) a ground cover substrate for disposition on a ground surface;
b) at least one element associated with said ground cover substrate for representing a standing or waiting position for a pedestrian individual and in which an activity may take place;
c) a first informational message located at said substrate and which is substitutable so that a second informational substrate may be readily and quickly substituted at said substrate for said first informational message so that only said second message is visibly presented; and
d) said substrate comprising a first layer of a relatively rigid material, which is generally transparent allowing an informational message to show therethrough and which provides sufficient weight to the substrate so that edges do not curl when disposed on a ground substrate, and a second layer of a relatively flexible material secured to said first layer and which aids in allowing the substrate to be rolled and also to be treated as a rigid mat.

7. The system of claim 6 further characterized in that said first information message is located at an underside of said first layer and under said generally transparent first layer so that said first informational message appears directly through said first layer.

8. The system of claim 6 further characterized in that the element representing a standing or waiting position is removable from said substrate so that a new element can be substituted therefor.

9. The system of claim 8 further characterized in that said element representing a standing or waiting position is fitted into a recess formed in the ground cover substrate for holding same.

10. The system of claim 7 further characterized in that the first informational message is ink printed on the underside of the first layer.

11. The system of claim 7 further characterized in that the first informational message is printed on a sheet material located at an underside of said first layer.

12. The system of claim 7 further characterized in that said second informational message can be substituted for said first informational message by applying an applique to said first substrate located over the first informational message.

13. The system of claim 6 further characterized in that said first layer is comprised of a polycarbonate material and said second layer is comprised of an acrylonitrile butadiene styrene copolymer.

14. The system of claim 13 further characterized in that said first layer has a thickness of no greater than one-fourth inch and said second layer has a thickness of no greater than one-fourth inch.

15. A personnel location and control system comprising at least one mat for guiding and locating a group of pedestrian individuals and also presenting an informational message to said pedestrian individuals during the movement of or standing at a location, said mat comprising:
a) a ground cover substrate for disposition on a ground surface;
b) means for presenting a message at an upper surface of said substrate in such manner that the message is observable by the pedestrian individuals during movement or at a standing location; and
c) said ground cover substrate being comprised of
1) a first layer of a relatively rigid and generally transparent polycarbonate material;
2) a second layer of an acrylonitrile butadiene styrene material; and
3) a bonding layer between said first and second layers to cause a bonding of the two.

16. The system of claim 15 further characterized in that a group of elements is associated with said ground cover substrate to define a pathway for guiding the movement of or a standing location for each of the pedestrian individuals.

17. The system of claim 16 further characterized in that there is a plurality of small discrete elements defining a pathway of movement for the pedestrian individuals and an elongate element defining an end of the line position for a person at the head of the line of pedestrian individuals.

18. The system of claim 15 further characterized in that said first information message is located between said first layer and said second layer.

19. A method of controlling the locational movement of one or more pedestrian individuals in a line of such individuals to an end of a line position and to a destination in advance of the end of the line position and simultaneously providing an informational message to said one or more pedestrian individuals, said method comprising:
a) providing a ground cover substrate to a ground surface and having an upper surface thereon for walking disposition by said one or more pedestrian individuals;
b) providing one or more elements on said upper surface of said substrate to represent a location for said one or more pedestrian individuals in which a particular activity may occur; and
c) locating an upstanding physical guide post in proximity to an edge of said ground cover substrate to alert the pedestrians in the pathway of a potential change of orientation of the pathway in advance of reaching that change of orientation.

20. The method of claim 19 further characterized in that said method comprises locating an informational message on said substrate in a position where the same is readily visible to and viewable by the one or more pedestrian individuals.
